(19) United States
(12) Patent Application Publication
(10) Pub. No.: US 2016/0030944 A1
(43) Pub. Date: Feb. 4, 2016

(54) ATTRITOR

(71) Applicant: General Electric Company, Schenectady, NY (US)

(72) Inventor: Luis Granados, Houston, TX (US)

(21) Appl. No.: 14/450,370

(22) Filed: Aug. 4, 2014

(51) Int. Cl. B02C 23/16; B02C 17/16; B02C 17/20; B02C 17/02

(52) U.S. Cl. CPC B02C 23/16; B02C 17/02; B02C 17/16; B02C 17/20; B02C 2023/165

(57) ABSTRACT

The present application provides an attritor for reducing particles in size. The attritor may include a tank, one or more screens therein, a number of arms rotating therein, and a grinding media therein. The screens define a number of chambers therein such that the arms and the grinding media reduce the size of the particles in a first chamber to a first predetermined size and reduce the size of the particles in a second chamber to a second predetermined size.

### TECHNICAL FIELD

The present application and the resultant patent relate generally to mixers and grinders for use with a flow of a coal slurry and the like and more particularly relate to a continuous flow attritor producing a substantially uniform particle size distribution therein.

### BACKGROUND OF THE INVENTION

Syngas may be produced by using a gasification process in which a carbonaceous fuel source such as coal reacts with oxygen within a gasifier. The carbonaceous fuel source may include a coal slurry in which coal particles are dispersed within a liquid. The coal particles should be reduced to a substantially uniform predetermined size before the reaction. One common type of a grinding or a dispersing device for coal is an attritor. The coal slurry may be premixed with a grinding media and pumped into an attrition vessel. The coal slurry and the grinding media are then agitated within the tank by a rotating shaft with a number of arms. This action causes the grinding media (spherical steal bearing balls) to exert shearing and impact forces on the particles in the coal slurry so as to reduce the size of the particles before use in the gasifier and/or other processing.

Current attritor designs, however, may require the use of an oversized injection pump given the use of the inlet port at the bottom of the tank. The injection pump needs to overcome not only the pipe and pipe accessories at the inlet but also the hydrostatic pressure of the column therein. Injecting the coal slurry at the bottom of the tank and removing the coal slurry at the top of the tank may create concentration surges developing along the height of the tank. These concentration surges may be defined by concentration profiles or non-uniform particle sizes that may be denser at the bottom and lighter on the top. Given such, the flow at the inlet port and at the discharge port of a conventional attritor may not have the same solids or particle size distribution therein such that the flow therethrough cannot be steady state or continuous in mass and concentration.

There is thus a desire for an improved attritor and methods of use thereof. Preferably such an improved attritor may provide substantially steady state, continuous flow with a substantially uniform particle size distribution therein. Moreover, the effective costs of operation also may be reduced herein by reducing the size or capacity of the injection pump and the like.

### SUMMARY OF THE INVENTION

The present application and the resultant patent provide an attritor for reducing particles in size. The attritor may include a tank, one or more screens therein, a number of arms rotating therein, and a grinding media therein. The screens define a number of chambers therein such that the arms and the grinding media reduce the size of the particles in a first chamber to a first predetermined size and reduce the size of the particles in a second chamber to a second predetermined size.

The present application and the resultant patent further provide a method of reducing particles in size in an attritor. The method may include the steps of pumping the particles to a top of the attritor, agitating the particles in a first chamber to a first predetermined size, dropping the particles into a second chamber, agitating the particles in the second chamber to a second predetermined size, and discharging the particles at a bottom of the attritor.

The present application and the resultant patent further provide for an attritor for reducing coal particles in size. The attritor may include a tank, a first screen defining an upper chamber, a second screen defining a lower chamber, a number of arms rotating therein, and a grinding media therein. The arms and the grinding media reduce the size of the coal particles in the upper chamber to a first predetermined size and further reduce the size of the coal particles in the lower chamber to a second predetermined size therein.

These and other features and improvements of the present application and the resultant patent should become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of an attritor and related components as may be described herein.

FIG. 2 is a schematic diagram of the interaction of coal slurry and a grinding media for use in the attritor of FIG. 1.

### DETAILED DESCRIPTION

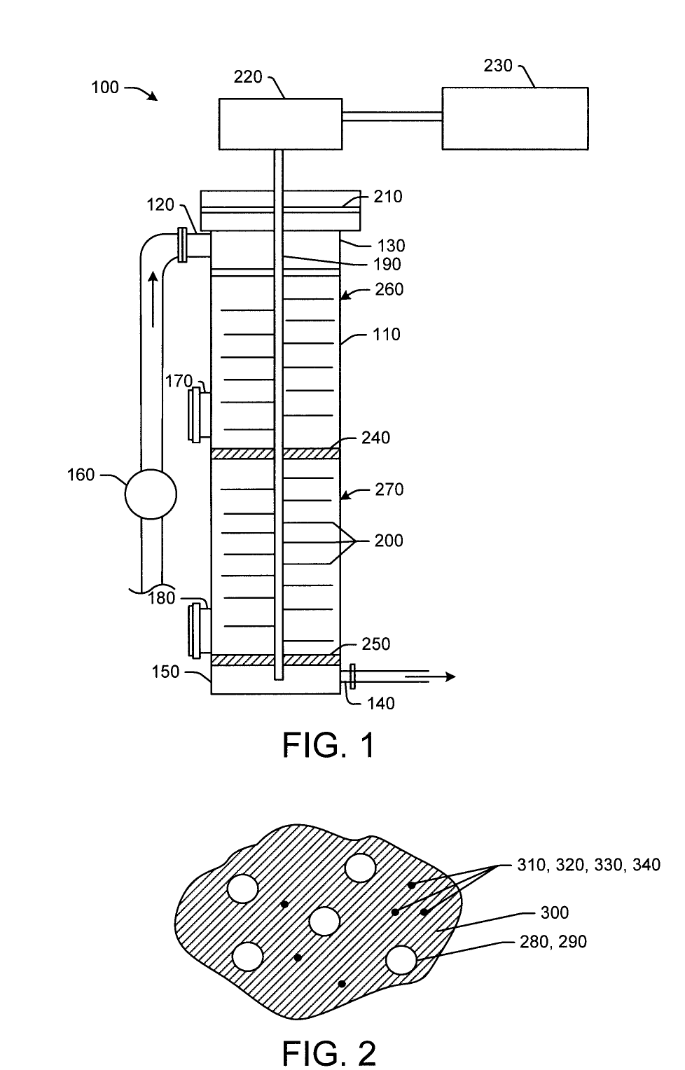

Referring now to the drawings, in which like numerals refer to like elements throughout the several views, FIG. 1 shows an example of an attritor 100 as may be described herein. The attritor 100 may include a tank 110. The tank 110 may be any type of vertical vessel. The tank 110 may be substantially hollow. The tank 110 may be made out of a substantially abrasion resistant steel or similar type of materials. The tank 110 may have a lining therein to protect further against abrasion, erosion, corrosion, and the like. In this example, the tank 110 may have a height of about 100 inches (about 254 centimeters) and a diameter of about 36 inches (about 93 centimeters) or so. The tank 110, however, may have any suitable size, shape, or configuration to meet a specific capacity.

The tank 110 may have an inlet port 120 positioned about a top end 130 thereof. The tank 110 also may have a discharge port 140 about a bottom end 150 thereof. The inlet port 120 and the discharge port 140 may have any suitable size, shape, or configuration. Multiple inlet ports 120 and/or discharge ports 140 also may be used herein. One or more slurry pumps 160 and the like may be in communication with the inlet pump 120. The slurry pump 160 may be of conventional design and may have any suitable size or capacity. The tank 110 also may have a number of manholes positioned thereon. In this example, a first manhole 170 and a second manhole 180 are shown. Any number of the manholes may be used herein. The manholes 170, 180 may have any suitable size, shape, or configuration. Other components and other configurations may be used herein.

The attritor 100 may include a rotating shaft 190 with a number of arms 200 positioned within the tank 110. The rotating shaft 190 may extend about the length of the tank 110 while the arms 200 may extend within the width thereof Any number of the arms 200 may be used in any suitable size, shape, or configuration. The arms 200 may have uniform or differing shapes. The rotating shaft 190 and the arms 200 may be made out of any type of substantially abrasion resistant material. As is shown, the arms 200 may have a somewhat staggered positioning along the length of the rotating shaft 190. Other positions may be used herein.

The rotating shaft 190 may be suspended at the top 130 of the tank 110 by a thrust-radial roller bearing 210 and the like. The roller bearing 210 may be of conventional design and may have any suitable size, shape, or configuration. The roller bearing 210 may be removable such that the rotating shaft 190 may be replaced via the top 130 of the tank 110. The rotating shaft 190 may be connected to a gear reducer 220 and a motor 230. The gear reducer 220 and the motor 230 may be of conventional design and may have any suitable size, shape, configuration, or capacity. The motor 230 may be a conventional electric motor. The gear reducer 220 may bring the nominal speed of the motor 230 from about 1800 revolutions per minute to about 90 revolutions per minute. Other speeds and speed ratios may be used herein. Other type of drive means and gearing means may be used herein.

The attritor 100 also may include a number of mesh screens 240 positioned within the tank 110. In this example, a first screen 240 and a second screen 250 are shown. Any number of screens may be used herein. The first screen 240 may have a mesh of about 700 micrometers or may be in a range from about 600 to about 1200 micrometers or so. The second screen 250 may have a mesh of about 350 micrometers or may be in a range from of about 20 to about 590 micrometers. The screens may be made out of any type of substantially abrasion resistant material. Other sizes, shapes, and configurations may be used herein. The screens 240, 250 may divide the tank 110 into an upper chamber 260 and a lower chamber 270. The chambers may have the same or differing volumes. Any number of the chambers may be used herein. Other components and other configurations may be used herein.

As is shown in FIG. 2, the attritor 100 may be used to grind sequentially a number of particles 280 from a first larger size to a second smaller size. In this example, the particles 280 may be coal particles 290 suspended in a slurry 300. Other types of particles 280 may be used herein. The grinding process may involve the interaction of the particles 280 with a grinding media 310. In this example, the grinding media 310 may be in the form of a number of chrome steel balls 320. Other types of grinding media 310 and other types of materials may be used herein. The grinding media 310 may have differing sizes. In this example, an upper grinding media 330 in the upper chamber 260 may have a diameter of about 0.5 inches or so (about 1.27 centimeters) while a lower grinding media 350 in the lower chamber 270 may have a diameter of about a 0.25 inches or so (about 0.635 centimeters). Other suitable sizes, shapes, or configurations may be used herein.

In use, about two-thirds or so of the upper chamber 260 and the lower chamber 270 may be filled with the grinding media 310. Other volumes may be used herein. The coal slurry 300 may be pumped to the top 130 of the tank 110 into the inlet port 120. The coal slurry 300 thus settles into the tank 130 under the force of gravity. Upon entry, the coal particles 290 may have an average diameter of about 2 millimeters. The grinding media 310 may be forced into motion via rotation of the arms 200 by the rotating shaft 190, the roller bearing 210, the gear reducer 220, and the motor 230. The rotation of the arms 200 moves the grinding media 310 and creates a violent interaction with the coal particles 290. This agitating interaction of media to coal, coal to coal, and coal to wall (of the tank) thus reduces the size of the coal slurry particles in a substantially uniform fashion.

Once the coal particles 290 have been reduced to about 300 micrometers in diameter in the upper chamber 260, the particles 290 are appropriately sized to pass through the mesh of the first screen 240 and fall into the lower chamber 270 under the force of gravity. The smaller lower grinding media 340 used in the lower chamber 270 continues the reduction in the size of the coal particles 290. The coal particles 290 thus may be reduced from about 300 micrometers to about 15 to about 20 micrometers or so. At this size, the coal particles 290 may fall through the mesh of the second screen 250 and into the discharge port 140 under the force of gravity. The grinding in the lower chamber 270 also may be assisted by upper grinding media 330 from the upper chamber 260 that may have degraded and fallen into the lower chamber 270. This degraded media will continue interaction with the coal particles 290 and assist in a further size reduction therein. The coal particles 290 thus may have a uniform particle size distribution upon leaving the discharge port 140. The grinding media 310 may be removed from the coal slurry 300 via magnetic means, a settlement tank, and the like. Other types of separation means may be used herein.

Given the use of the inlet port 120 at the top end 130 of the tank 110, the slurry pump 160 of the attritor 100 need only be sized to pump the coal slurry 300 from ground level to the inlet port 120 instead of all of the way through the tank 110 from the bottom end 150 thereof. Moreover, the degradation of the grinding media 310 may be slower given the use of the upper chamber 260 and the lower chamber 270 in that the grinding media 310 from the upper chamber 260 will continue to work in the lower chamber 270.

Given the use of the two sequential chambers 260, 270 with each chamber dedicated to a specific particle size distribution, the attritor 100 largely mimics the operation of a steady state, continuous flow device even if each chamber in fact acts on a batch basis. Specifically, the attritor 100 may avoid the concentration surges that create concentration profiles along the height of the tank 130 as may be found in known devices given the use of the multiple chambers. Any number of the chambers may be used herein with more chambers possibly more closely approximating an actual continuous, steady state flow in mass and concentration. Each chamber further reduces the particle size in sequence.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

I claim:

1. An attritor for reducing particles in size, comprising:
a tank;
one or more screens therein;
a plurality of arms rotating therein; and
a grinding media therein;
the one or more screens defining a plurality of chambers therein such that the plurality of arms and the grinding media reduce the size of the particles in a first chamber to a first predetermined size and reduce the size of the particles in a second chamber to a second predetermined size.

2. The attritor of claim 1, wherein the tank comprises an inlet port at a top thereof and a discharge port at a bottom thereof.

3. The attritor of claim 1, further comprising a pump in communication with the inlet port.

4. The attritor of claim 1, wherein the tank comprises one or more manholes thereon.

5. The attritor of claim 1, further comprising a rotating shaft attached to the plurality of arms.

6. The attritor of claim 5, further comprising a roller bearing in communication with the rotating shaft.

7. The attritor of claim 5, further comprising a gear reducer in communication with the rotating shaft.

8. The attritor of claim 5, further comprising a motor in communication with the rotating shaft.

9. The attritor of claim 1, wherein the one or more screens comprise a first screen and a second screen.

10. The attritor of claim 9, wherein the first screen comprises a first screen mesh of a first predetermined size and wherein the second screen comprises a second screen mesh of a second predetermined size.

11. The attritor of claim 9, wherein the first screen comprises a first screen mesh of about 600 to about 1200 micrometers and wherein the second screen comprises a second screen mesh of about 20 to about 590 micrometers.

12. The attritor of claim 1, wherein the grinding media comprises steel balls.

13. The attritor of claim 1, wherein the grinding media comprises a first grinding media size of about 0.5 inches (about 1.27 centimeters) and a second grinding media size of about a 0.25 inches (about 0.635 centimeters).

14. The attritor of claim 1, wherein the particles comprise coal particles in a slurry.

15. A method of reducing particles in size in an attritor, comprising:
pumping the particles to a top of the attritor;
agitating the particles in a first chamber to a first predetermined size;
dropping the particles into a second chamber;
agitating the particles in the second chamber to a second predetermined size; and
discharging the particles at a bottom of the attritor.

16. An attritor for reducing coal particles in size, comprising:
a tank;
a first screen defining an upper chamber;
a second screen defining a lower chamber;
a plurality of arms rotating therein; and
a grinding media therein;
the plurality of arms and the grinding media reduce the size of the coal particles in the upper chamber to a first predetermined size and reduce the size of the coal particles in the lower chamber to a second predetermined size.

17. The attritor of claim 16, wherein the tank comprises an inlet port at a top thereof and a discharge port at a bottom thereof.

18. The attritor of claim 16, further comprising a pump in communication with the inlet port.

19. The attritor of claim 16, wherein the first screen comprises a first screen mesh of a first predetermined size and wherein the second screen comprises a second screen mesh of a second predetermined size.

20. The attritor of claim 16, wherein the grinding media comprises chrome steel balls.
